(19) United States
(12) Patent Application Publication
(10) Pub. No.: US 2017/0204658 A1
(43) Pub. Date: Jul. 20, 2017

(54) ORIENTING DEVICE, SOLAR TRACKING SYSTEM AND METHOD THEREFOR

(71) Applicant: SOLARSWING HOLDING B.V., Delft (NL)

(72) Inventors: Sam KIN, Amsterdam (NL); Sander TEN KATE, Amsterdam (NL)

(73) Assignee: SOLARSWING HOLDING B.V., Delft (NL)

(21) Appl. No.: 15/116,935

(22) PCT Filed: Feb. 9, 2015
(86) PCT No.: PCT/NL2015/050084

§ 371 Date: Aug. 5, 2016

(30) Foreign Application Priority Data
Feb. 7, 2014 (NL) 2012229
Aug. 5, 2014 (NL) 2013304

(51) Int. Cl. E06B 9/36; E06B 9/386; G01S 3/786

(52) U.S. Cl. CPC E06B 9/368; G01S 3/7861; E06B 9/361; E06B 9/386; E06B 2009/2417

(57) ABSTRACT

A device for orienting slats relative to the sun includes a housing, an elongate guide which is connected to the housing and in which the slats are engageable and guidable, a drive with which the slats, which extend substantially transversely of the elongate guide, are rotatably drivable about their longitudinal axis, a controller configured to control the drive such that the slats are orientable relative to the sun, and rotational position determining mechanism configured to detertmine the rotational position of the slats. A solar tracking system is provided for orienting slats relative to the sun, and including such an orienting device. A method is provided for orienting slats with such an orienting device.

The invention relates to an orienting device for a solar tracking system, such a solar tracking system and a method therefor.

It is a known problem that it can become very warm in buildings when the windows in the outer walls are exposed to sunlight. In order to keep the temperature in a comfortable range energy-requiring air-conditioning systems are employed which then cool the space inside the building.

In order to prevent undesired heating windows are often provided with sun protection. It is known in the case of large (office) buildings to give such sun protection an automatic form; when there is a great deal of sunlight the sun protection is then closed, usually by lowering solar protection elements.

The drawback of conventional sun protection is that blocking the direct sunlight also results in it becoming dark, and this is often undesired. On a day with variable light conditions it can moreover already become dark quickly when the sun goes in for a while, in which case an open position of the sun protection is preferred. In such variable light conditions an automatic system will for this reason switch automatically several times a day between a closed and an open position of the sun protection.

An object of the present invention is to provide a device and system wherein said drawbacks do not occur, or at least do so to lesser extent.

Said object is achieved according to the invention with the device for orienting slats relative to the sun, comprising:
an elongate housing;
an elongate guide connected to the housing and having engaging elements which engage the slats during use and are displaceable in the longitudinal direction of the elongate housing, wherein the slats are rotatable about a longitudinal axis thereof;
drive means which act selectively on the rotatable slats and with which the slats, which extend substantially transversely of the elongate guide, are selectively rotatable about the longitudinal axis thereof;
control means configured to control the drive means subject to a rotational position of the slats relative to the sun; and
rotational position determining means configured to determine the rotational position of the slats relative to the housing.

The control means calculate the position of the sun and ensure via control of the drive means that the slats are rotated such that the slats remain oriented substantially perpendicularly of the sun.

It is acknowledged here that the prior art relating to the present invention includes the publication DE-2800968.

According to the invention the housing comprises two housing parts, and the device comprises a first housing part in which the drive means are arranged, a second housing part in which at least the control means are arranged, and wherein the second housing part is connectable to one of at least two sides of the first housing part. Because the housing can be assembled from two housing parts, wherein the second housing part is connectable to two sides of the first housing part, the orienting device can be easily adapted to and modified between two mirrored embodiments. That is, a first embodiment wherein the housing is situated on the right-hand side of the guide and the slats, and a second embodiment wherein the housing is situated on the left-hand side of the guide and the slats.

When the first housing part in which the drive means are arranged is arranged substantially in line with the elongate guide in which the slats are engageable and guidable, the drive means can engage in simple manner on this guide.

According to a further preferred embodiment, the rotational position determining means comprise optical or magnetic sensors. Optical sensors have the advantage that they enable contactless measurement, thereby preventing the slats being undesirably adjusted as a result of a mechanical load. Magnetic sensors such as Hall sensors are easy to combine even with small and light magnets such as permanent magnets in order to be able to determine in highly reliable manner an actual momentary angular position of the slats relative to the guide on the basis of detected field strength and/or field line orientation of the magnetic field from the magnet or magnets. An angular position of the slats relative to the guide and therefore also, when prior knowledge is available about a position of the guide relative to for instance a more absolute orientation such as a north-south orientation, relative to a position of the sun can thus be determined in highly reliable manner as a momentary actual position. When this is compared to a desired position, which can be based solely on an actual position of the sun on a day in the year, or more broadly a season, modification, adjustment or rotation of the slats is possible from an actual position to a desired position.

According to yet another preferred embodiment, the optical sensors are arranged in a recess which takes a form running from the first housing part to the second housing part. This recess can protect the optical sensors and allows an extra volume of the housing.

According to yet another preferred embodiment, the recess arranged in the second housing part takes a mirrored form. The second housing part is hereby connectable to at least two sides of the first housing part, and a recess running from the first housing part to the second housing part is in this way obtained in both coupled situations.

According to yet another preferred embodiment, the slats are received in the guide for displacement in longitudinal direction, and the device further comprises translational position determining means for determining the translational position of the slats. Because the slats are displaceable in longitudinal direction of the guide, they can slide closed and open. Because the slats must be drawn sufficiently far open in order to be able to rotate, means are also provided with which the distance between adjacent slats can be (indirectly) determined.

A determination is preferably made as to whether the slats have been drawn fully open by providing detection means at the outer end of the guide. According to yet another preferred embodiment, the translational position determining means for determining the translational position of the slats comprise a switch arranged on or close to an outer end of the guide remote from the housing. When a slat makes contact with the switch, it sends a corresponding signal to the control means which are thereby informed that the slats are in a drawn open position which allows a substantially free rotation around their longitudinal axis.

According to yet another preferred embodiment, a magnetic connection which holds the slats in a fully drawn open position is provided on or close to the outer end of the guide remote from the housing. The slats are held fully drawn open by the magnetic connection and will not easily displace if an external force is accidentally exerted thereon. The magnetic connection thus provides a threshold value which prevents unintended displacement of the slats. The skilled person will appreciate that such a magnetic connection can be provided by at least providing a magnet on or close to the outer end of the guide and/or directly or indirectly on the outermost slat and by respectively providing the other co-acting part with a second magnet or giving it a metal form.

The invention further relates to a solar tracking system for orienting slats relative to the sun, comprising:
an orienting device as described in the foregoing; and
at least two slats which are arranged substantially parallel adjacently of and close to each other and which are received for rotation about their longitudinal axis in the guide.

Although it is possible to envisage the longitudinal direction of the slats extending in a substantially lying plane and for instance being arranged substantially parallel to a (transparent) roof, according to a preferred embodiment the longitudinal direction of the slats extends in a substantially standing plane. It hereby becomes possible to apply the solar tracking system for sun protection of windows in upright walls.

When the longitudinal direction of the slats extends in a substantially standing plane, the slats are preferably suspended from the guide. Owing to gravitational force hanging slats will automatically be oriented vertically.

In a particularly advantageous embodiment the slats comprise sun protection slats which are substantially transparent and which are provided with one or more optical elements. The optical elements are configured to reflect direct sunlight, while diffuse daylight can pass through almost completely. On a sunny day about 80% of the daylight consists of direct sunlight. Because the greater part of this direct sunlight is reflected, the associated heat is also reflected. These properties ensure that the slats, when applied as indoor sun protection, reflect the heat outward but meanwhile allow entry of daylight.

According to a further preferred embodiment, the optical elements comprise one or more prisms. A prismatic surface structure is preferably arranged on a side of a slat. Tests have shown that, because of the prisms, such a prismatic surface structure can reflect up to 96% of direct sunlight while a greater part of the diffuse daylight is allowed through. These exceptionally favourable results do depend however on the position of the slats relative to the incident sunlight: the slats have to be oriented substantially perpendicularly of the solar rays. The control means which control the drive means with which the slats are drivable rotatably about their longitudinal axis relative to the guide are configured to rotate the slats about their longitudinal axis during the course of the day such that the slats remain oriented substantially perpendicularly of the incident sunlight. The control means avoid manual adjustment being necessary: in the case of slats with prisms this would require, for optimum performance, the slats being manually adjusted every few minutes, and this is evidently not realistic. It is desirable that the slats remain accurately oriented to within half a degree perpendicularly of the sun.

According to yet another preferred embodiment, the slats comprise one or more solar cells. By providing one or more slats wholly or partially with solar cells—for instance on only a narrow edge on the upper side—solar energy can be used for the energy supply to the orienting device of the solar tracking system. A battery is preferably provided in which generated solar energy is stored, thereby guaranteeing that sufficient energy is always available for control of the orienting device.

The invention further relates to a method for orienting the slats with an orienting device as described above, comprising the calibration steps of:
rotating the slats in a first rotation direction with the drive means until they are detected by a sensor, wherein the rotational position at which this detection occurs is stored in the control means as a first end rotational position;
rotating the slats in a second rotation direction opposite to the first rotation direction with the drive means until they are detected by a sensor, wherein the rotational position at which this detection occurs is stored in the control means as a second end rotation position; and
wherein the control means determines the rotational displacement between the first end rotational position and the second end rotational position.

According to a preferred embodiment of the method, the control means determine the rotational displacement on the basis of the number of steps taken by an electric motor of the drive means between the first end rotational position and the second end rotational position.

According to a further preferred embodiment of the method, the slat rotated between the first end rotational position and the second end rotational position is connected to a disc which has openings arranged in peripheral direction and at which an optical sensor is directed. The rotational displacement can be measured very precisely with this arrangement.

According to a further preferred embodiment, the rotational displacement of at least one slat is measured with one or more magnetic sensors. Magnetic sensors provide the advantage that a contactless and reliable position determination is possible over the whole rotation movement of a slat.

The suspension of at least one slat and/or at least one slat itself is preferably provided with a magnet, and a magnetic sensor is arranged in the vicinity in order to detect the orientation of the magnet, and so of the slat with this magnet thereon.

It is particularly advantageous for at least one slat to be arranged under or close to a housing in which a magnetic sensor is received. The magnetic sensor is contactless and can be provided wholly out of sight in the housing.

The magnet of the slat is arranged very precisely in the measuring range of the magnetic sensor by providing the housing with a recess through which the slat provided with the magnet is rotatable.

According to yet another preferred embodiment, the magnetic sensors are configured to measure the electromagnetic field strength. It is hereby possible with the magnetic sensors to determine the absolute position of the slats in all positions.

According to yet another preferred embodiment of the method, the method further comprises the steps of:
entering into the control means the time, the geographical position and the geographical orientation of the guide of the orienting device;
the control means calculating the position of the sun relative to the guide; and
the control means controlling the drive means such that the slats are rotated such that the slats remain oriented substantially perpendicularly of the sun.

According to the invention the control means calculate passively where the sun is located at a determined geographical position at a determined point in time relative to the orienting device. ‘Passively’ is understood to mean that an active real-time measurement of the sun is unnecessary. The advantage of applying passive control means is that the orienting device can control the slats at all times and is not dependent on the sun being visible for this purpose. Weather conditions such as cloud in front of the sun are in this way prevented from affecting the operation of the orienting device.

Preferred embodiments of the present invention are further elucidated in the following description with reference to the drawing, in which:

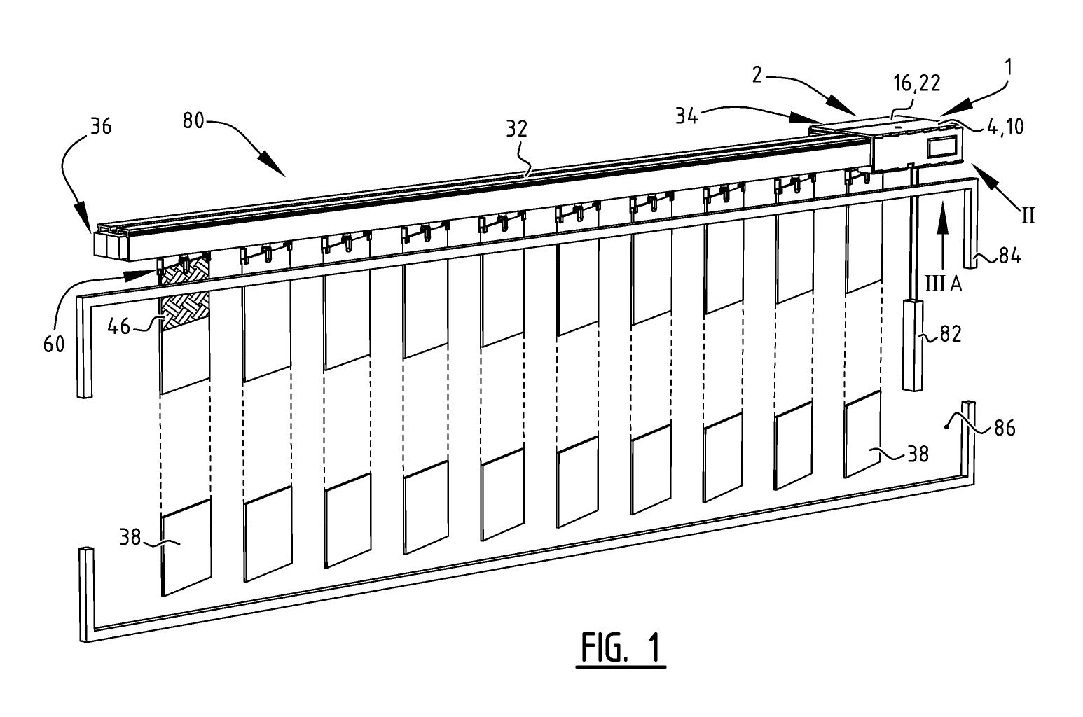

FIG. 1 is a perspective view of a window having behind it a solar tracking system according to the invention;

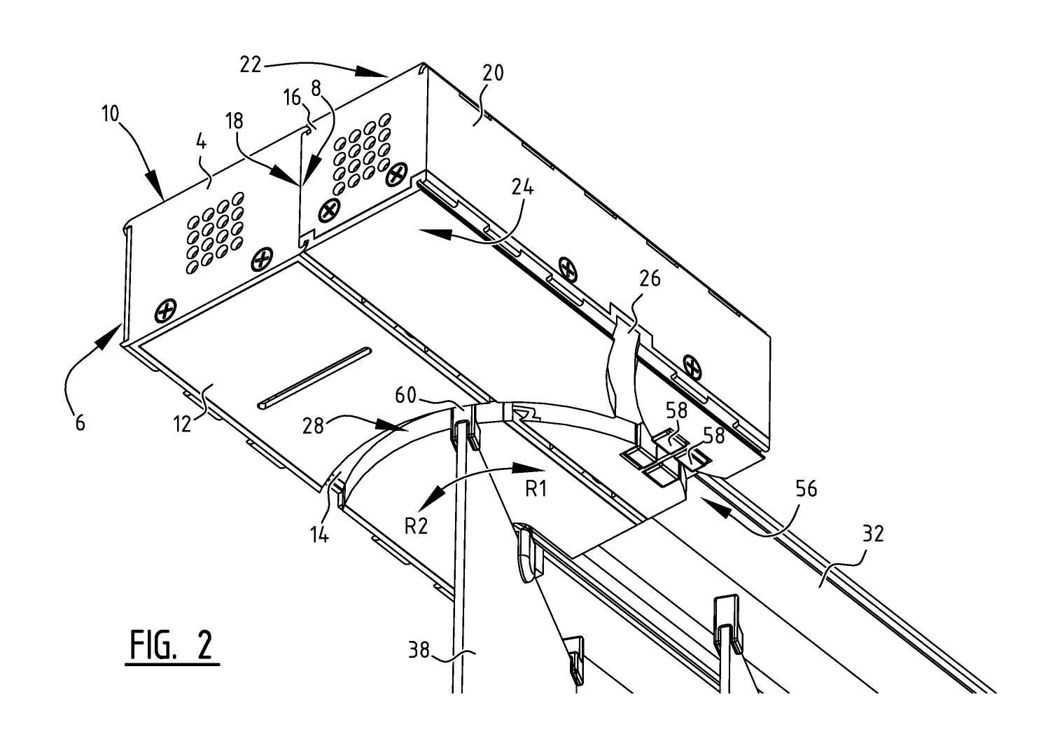

FIG. 2 is an enlarged perspective bottom view of the solar tracking system shown in FIG. 1 as seen from the rear;

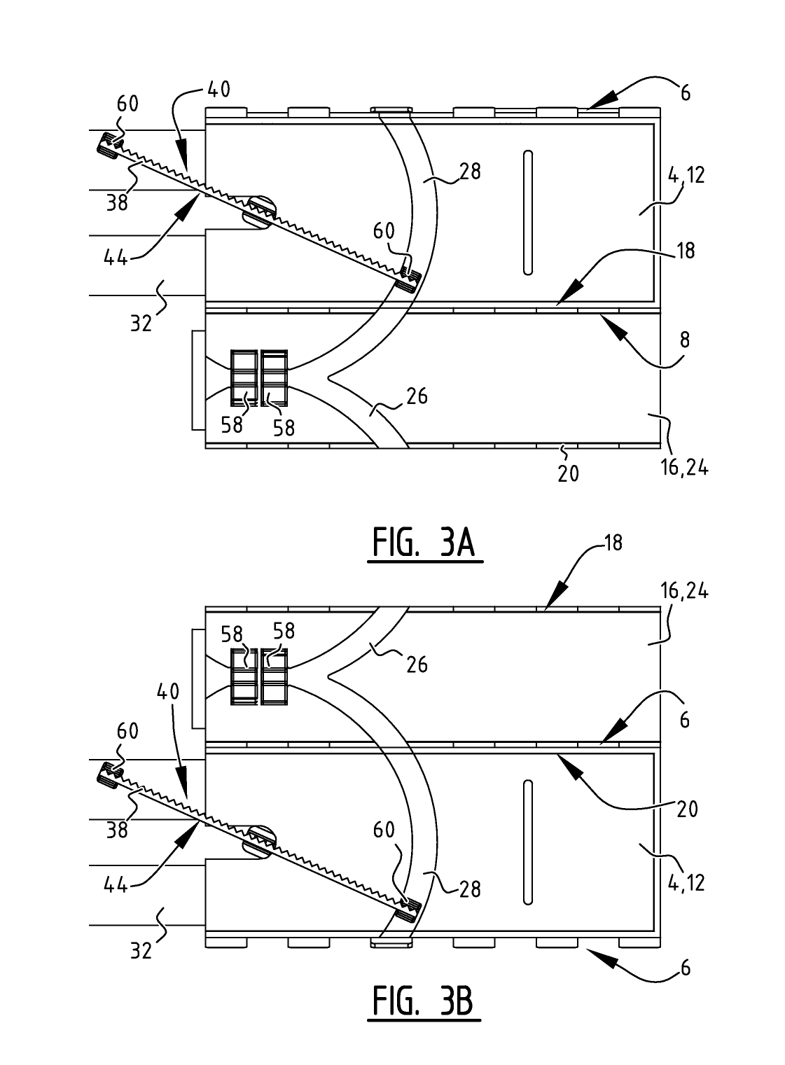

FIG. 3A is a detailed bottom view of the housing of the solar tracking system shown in FIGS. 1 and 2;

FIG. 3B is a detailed bottom view of the housing in an alternative, mirrored assembly;

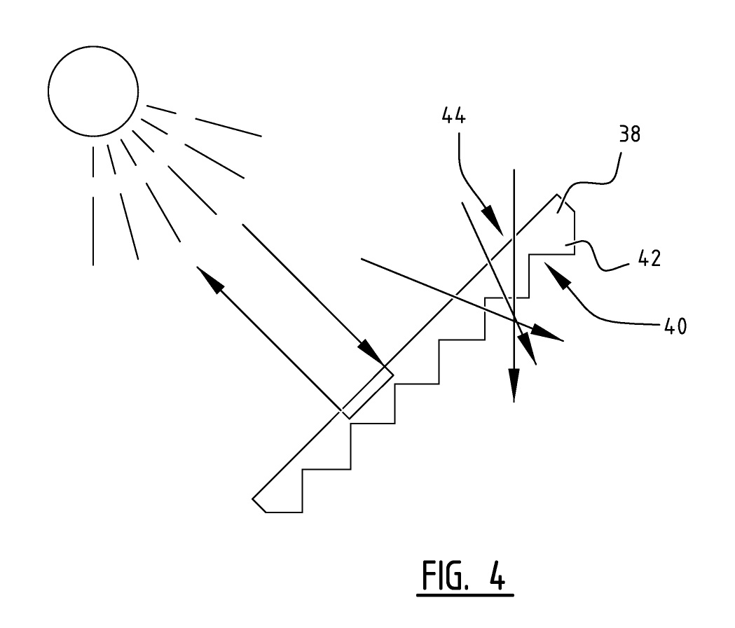

FIG. 4 is a schematic representation of the sun protection action of a slat provided with optical elements;

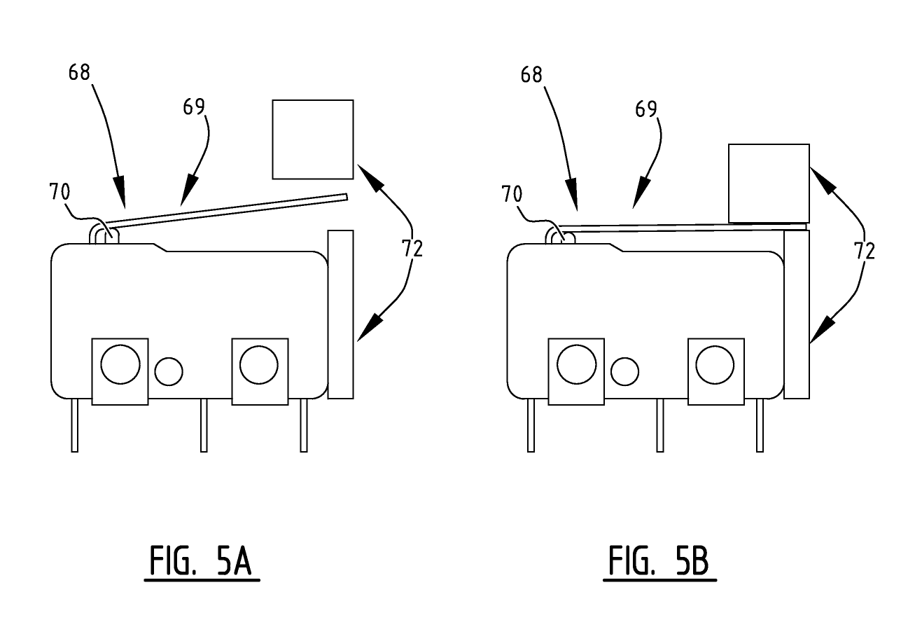

FIGS. 5A and 5B show two states of the translational position determining means according to an embodiment of the solar tracking system;

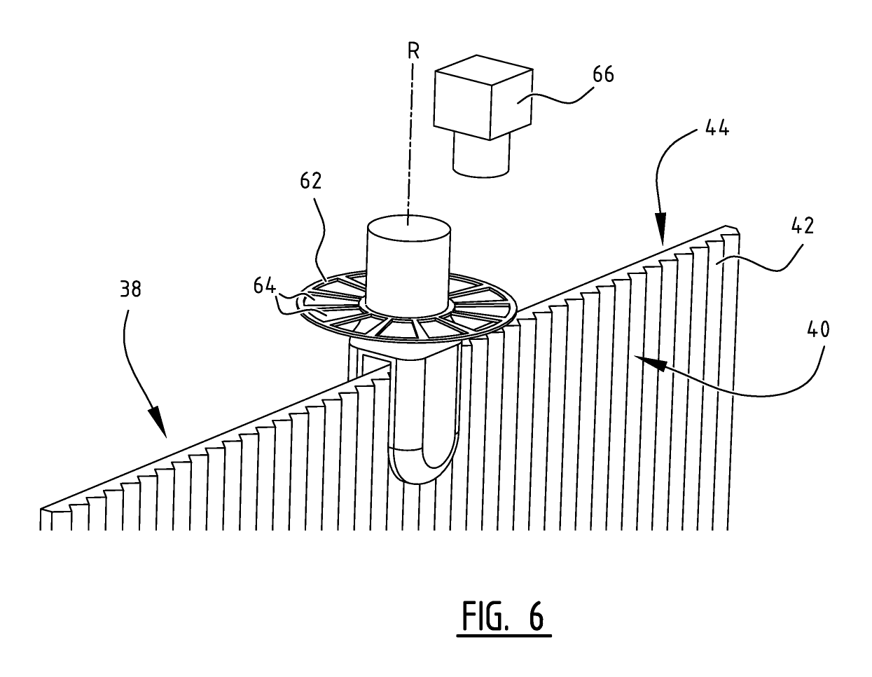

FIG. 6 is a perspective view of rotational position determining means according to a further embodiment;

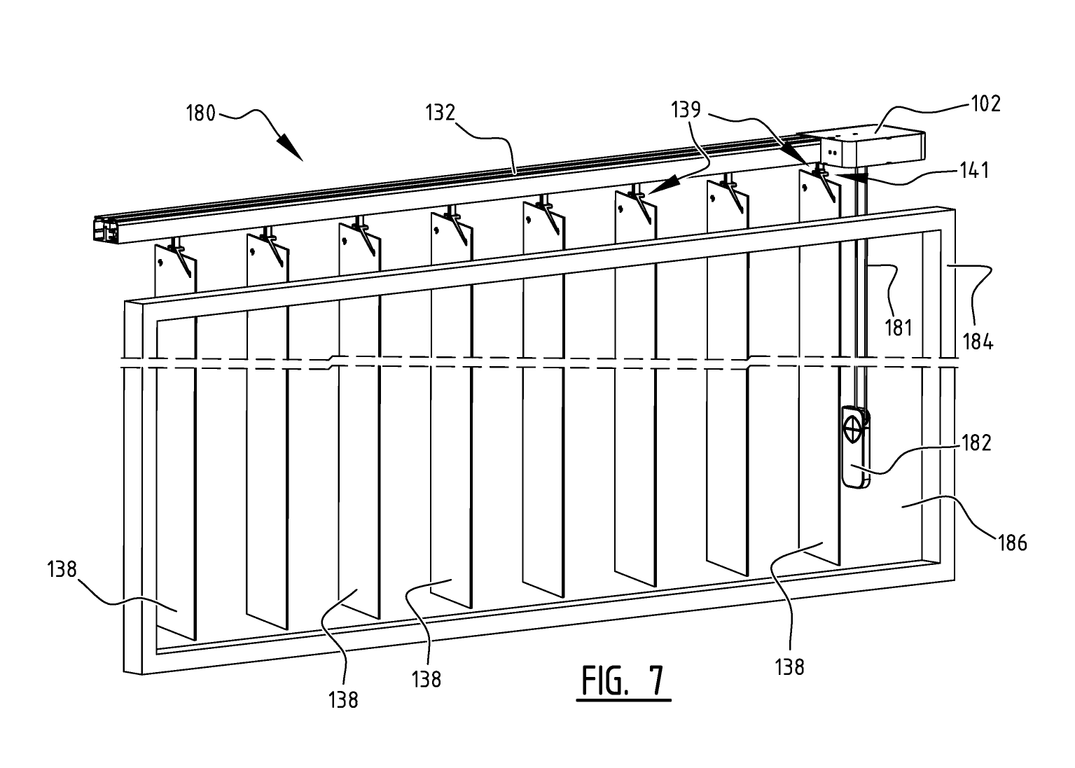

FIG. 7 is a perspective view of a window having behind it a solar tracking system according to a second embodiment of the invention;

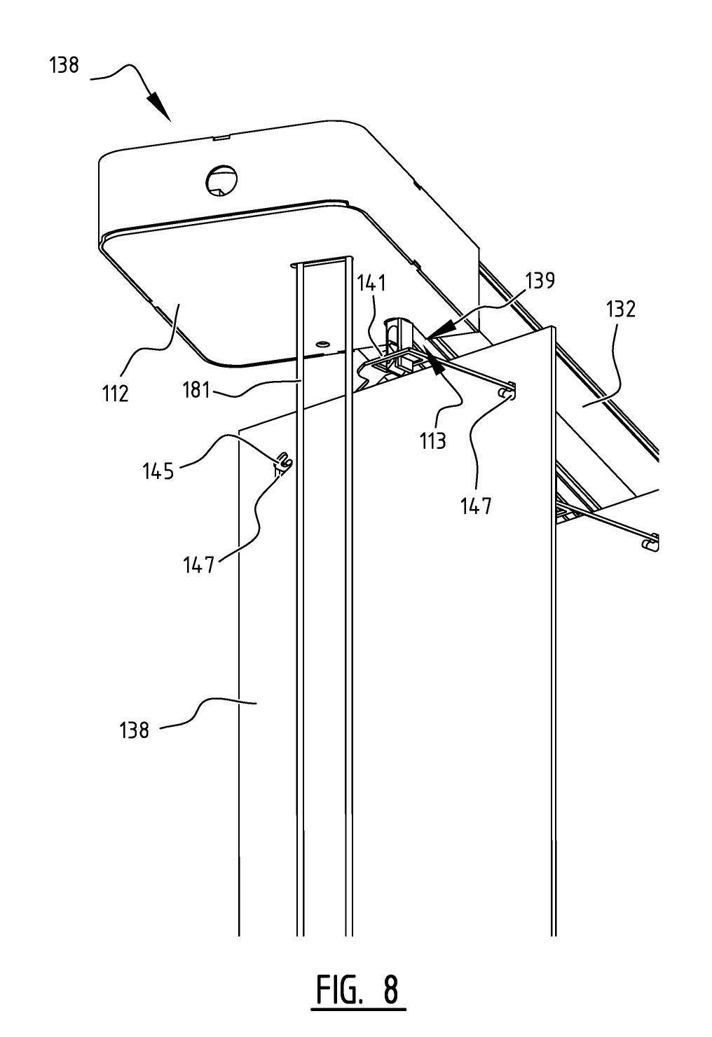

FIG. 8 is an enlarged perspective bottom view of the solar tracking system shown in FIG. 7 as seen from the rear;

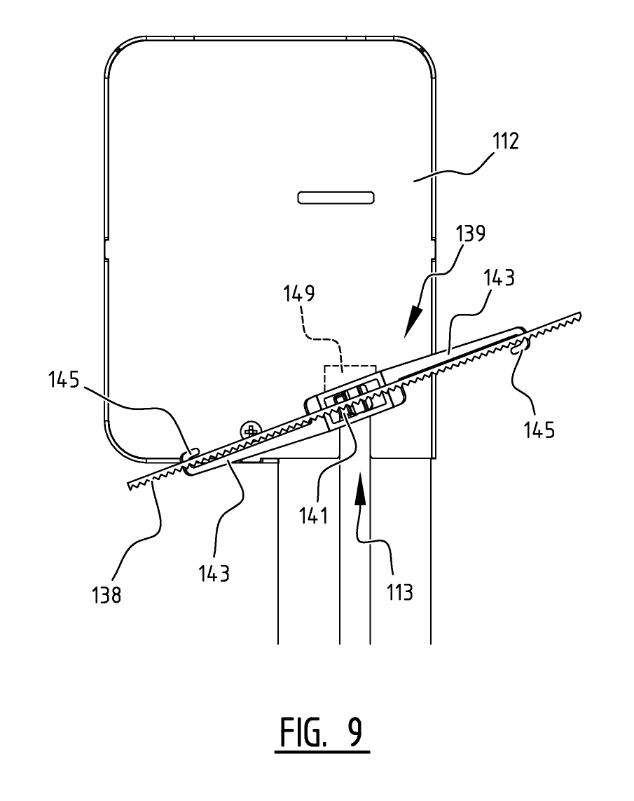

FIG. 9 is a detailed bottom view of the housing of the solar tracking system shown in FIGS. 7 and 8; and

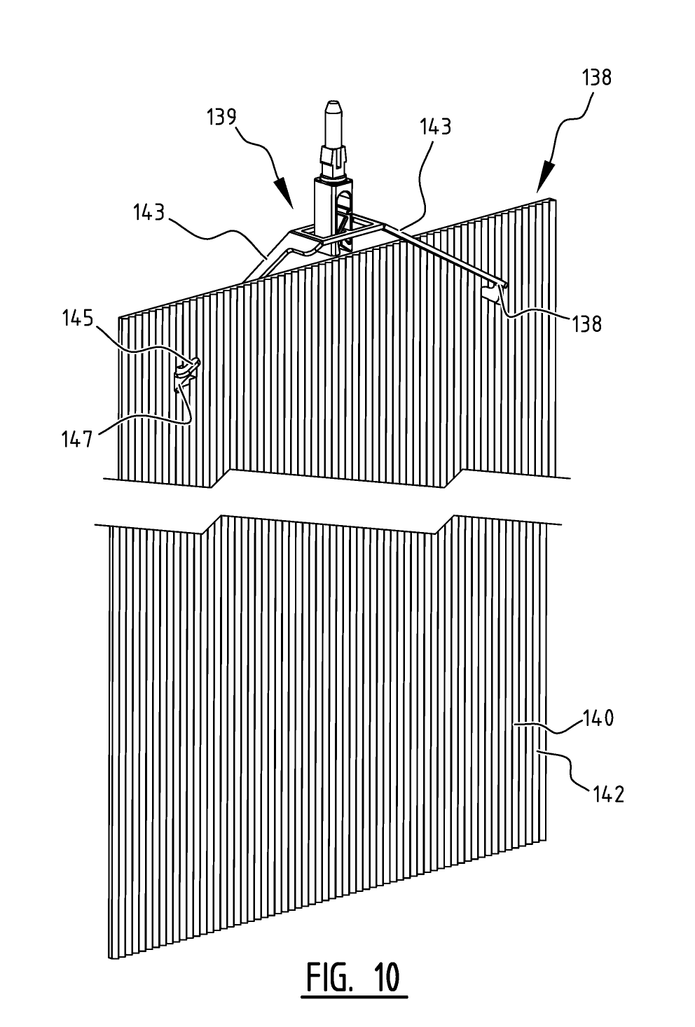

FIG. 10 is a perspective view of the mounting of a slat according to the embodiment shown in FIGS. 7-9.

Arranged behind the window frame 84 with transparent window 86 shown in FIG. 1 is a solar tracking system 80 with an orienting device according to the invention. Slats 38 are slidable in longitudinal direction in guide 32 with a cord control 82 or optional remote control, whereby slats 38 can slide open or closed. One or more slats 38 can optionally be wholly or partially provided with solar cells 46 for generating electrical energy.

The orienting device comprises a housing 2 which in a particularly advantageous embodiment is assembled from a first housing part 4 and a second housing part 16, as will be further elucidated with reference to FIGS. 3A and 3B.

Housing 2 is shown in the enlarged perspective bottom view of FIG. 2. First housing part 4 has a first longitudinal side 6, a second longitudinal side 8, an upper side 10 and an underside 12. Second housing part 16 has a first longitudinal side 18, a second longitudinal side 20, an upper side 22 and an underside 24.

A recess 14 is arranged in the underside 12 of first housing part 4 and the underside 24 of second housing part 16 is also provided with a recess 26. In assembled state of first housing part 4 and second housing part 16 these recesses 14 and 26 form a continuous channel 28 through which a detection protrusion 12 arranged on a slat 38 is movable and can be detected by optical sensors 58 forming rotational position determining means.

Although it is possible to envisage the optical sensors 58 being arranged on the underside 24 of second housing part 16, the embodiment with a continuous channel provides the advantage that optical sensors 58 are protected and the volume of first housing part 4 and second housing part 16 can be relatively large for the purpose of accommodating therein components such as drive means 50 and control means 52.

It is possible to envisage as alternative an embodiment (not shown) in which an optical sensor is oriented downward from the underside 24 of second housing part 16 or the underside 12 of first housing part 4 and detects when slat 38 rotates past.

In the calibration process the slat 38 is rotated in a first rotation direction R1 until slat 38 is detected by an optical sensor 58, wherein this detected rotational position is stored as a first end rotational position in control means 52. Slat 38 is subsequently rotated by drive means 50 in a second rotation direction R2 opposite to the first rotation direction R1 until slat 38 is detected by a sensor 58. This rotational position at which detection once again occurs is stored as a second end rotational position in control means 52. Because control means 52 has recorded the rotational displacement between the first end rotational position and the second end rotational position, for instance by recording the number of steps taken by an electric motor of drive means 50 between the first end rotational position and the second end rotational position, control means 52 know the exact rotational position of slat 38.

Because it is advantageous to be able to decide on site whether housing 2 has to be arranged on the left or right-hand side of window frame 84, it is desirable that housing 2 allows a left-hand and a right-hand mounting. Housing 2 of orienting device 1 is divided for this purpose into two housing parts, wherein first housing part 4 and second housing part 16 are connectable to each other with at least two sides. The bottom view shown in FIG. 3A shows that second housing part 16 is coupled with its first longitudinal side 18 to second longitudinal side 8 of first housing part 4.

In the mirrored arrangement shown in FIG. 3B the second housing part 16 is coupled with its second longitudinal side 20 to first longitudinal side 6 of first housing part 4.

In the shown embodiment the second housing part 16 is provided with mirrored recesses 26 so that a continuous channel 28 is obtained in both configurations, i.e. in the situations shown in FIG. 3A and in FIG. 3B.

Shown in the schematic view of FIG. 4 is a slat 38 which is provided with a prismatic structure 42 on a first side 40 and which takes a flat form on second side 44. When solar rays impinge on optical elements 42 at a correct angle, the prismatic surface structure 42 will be able to reflect up to 96% of the direct sunlight, while the greater part of the diffuse daylight is allowed through. Because these exceptionally favourable results are greatly dependent on a correct perpendicular alignment of slats 38 relative to the incident sunlight, slats 38 are at all times held oriented substantially perpendicularly relative to the sun with the orienting device of solar tracking system 80.

Because slats 38 can only rotate freely when they are situated in the fully drawn open position shown in FIG. 1, the orienting device of solar tracking system 80 is provided with translational position determining means 68, an embodiment of which is shown in FIGS. 5A and 5B.

The translational position determining means 68 comprise a switch 70 which is pressed in by means of a lever 69 when slats 38 are situated in the drawn open position.

A magnetic connection 72 is preferably provided which holds the slats fixedly in this drawn open position and prevents them being accidentally displaced.

FIG. 6 shows an alternative embodiment of rotational position determining means 56, wherein a slat 38 is provided around its rotation axis with a detection disc 62 in which openings 64 are arranged. The rotational position of slats 38 can be determined very precisely by having the number of openings and intermediate connections counted by an optical sensor 66. Calibration can once again take place by moving the slats reciprocally between a first end rotational position and a second end rotational position so that determination of an initial position is possible.

A further embodiment of the invention wherein the rotational displacement of a slat is measured with a magnetic sensor is shown in FIGS. 7-10. Magnetic sensors provide the advantage that a contactless and reliable position determination is possible over the whole rotational movement of a slat.

Arranged behind the window frame 184 with transparent window 186 shown in FIG. 7 is a solar tracking system 180 with an orienting device according to the invention. Using a cord 181 and a control 182 the slats 138 are slidable in longitudinal direction in guide 132, whereby slats 138 can be slid closed and open. One or more slats 138 can once again optionally be wholly or partially provided with solar cells (not shown) for generating electrical energy.

The orienting device comprises a housing 102 shown in perspective bottom view in FIG. 8 and in bottom view in FIG. 9. Provided in the underside 112 is a recess 113 in which the first slat 138 is received for rotation via a carrier member 139. Such a carrier member 139 is shown in more detail in FIGS. 9 and 10 and comprises two carrier arms 143 provided on the outer ends with hook parts 145 which engage in recesses 147 arranged for this purpose in slats 138.

Carrier member 139 of first slat 138, i.e. the slat situated under housing 2, is provided with a magnet 141, in particular a permanent magnet, although other random types of magnet are by no means precluded.

Provided in housing 2 is a magnetic sensor which determines the position of magnet 141, and thereby the orientation of the slat 138 connected thereto. A possible example of such a magnetic sensor is a so-called Hall sensor. In the bottom view shown in FIG. 9 the position of the magnetic sensor received in the housing (and therefore not visible) is indicated schematically with the broken line block 149. Because all slats 138 are coupled to each other in respect of orientation and movement, a determination of the orientation of just one slat 138 suffices to determine and adjust the orientation such that the first sides 140 with the prismatic structure 142 are oriented substantially transversely of solar rays from the sun.

In another embodiment two magnets 141 are arranged on either side relative to a longitudinal axis of slat 138.

Magnetic sensor 149 is configured to detect magnetic fields generated by magnet 141 or magnets 141, in particular parameters thereof such as field line orientation and/or field strength, or both, or other parameters. On the basis of such detection results from magnetic sensor 149 a control can determine the actual momentary angular position of slat 138 at least relative to an orientation of the guide, or even for instance relative to a more absolute north-south orientation than the angular position relative to an orientation of elongate guide 132. This is possible using an algorithm, not further detailed, for determining the momentary angular position of slat 138, wherein the parameter is for instance that of field line orientation and the Hall sensor and the control are together configured to determine the orientation on the basis of field lines of the at least one magnet 141 determined by magnetic sensor 149.

The momentary position of slat 138 can be compared to a position thereof desired at that moment. The desired position can be based on sunlight detection, for instance with a sun sensor on for instance a slat 138, for instance by progressing through a calibration rotation of at least the associated slat 138, optionally at intervals, with the sun sensor and determining the position of the sun at this angular position of the sun sensor where the intensity is highest. Additionally or alternatively the momentarily desired position of the slats can be determined on the basis of prior knowledge of the position of the sun in a determined season or a specific day of the year and an orientation of guide 132.

A detected angular position of slat 138 can then—if necessary—be adjusted or adapted by a drive connected to the control for the purpose of adjusting the angular position of slats in order to rotate the slats 138 to an angular position thereof corresponding to the determined, measured, calculated or otherwise ascertained desired angular position of slats 138 in accordance with the actual position of the sun at that moment.

Provision is particularly though not exclusively made for an end position detection or at least a translational position determination. Thus made possible is that a limit can be set for an angular displacement of the slats when these are not or not wholly and not all distributed along guide 132. If a number of the slats lie close together, they cannot be rotated wholly in line with guide 132 without risk of damage because adjacent slats may then come up against each other's suspensions. A fraction of slats which are however already distributed along guide 132 can be determined relative to the overall number of slats. The control can be configured to distribute all slats along guide of 132 or, when determining the angular position of the slats desired at any moment, to take account of this fraction by limiting the angular displacement of the distributed slats and the compact cluster of the other slats to an overall angular position at which there is the least possible risk of damage.

It is noted that the configuration of the magnetic sensor on or at the guide and the at least one magnet on or at at least one of the slats can be reversed, with the sensor on the slat and the magnet on the guide. One of the sensor and the magnet can also be arranged on an element in the vicinity such as a window frame or wall in order to enable performing of the measurement of the momentary angular position of the slat.

The orientation of first slat 138 is determined for practical reasons in the shown embodiment because it can be located under housing 102. It will however be apparent to the skilled person that the determination of the orientation according to the invention can likewise he applied at another slat 138. It is noted for the sake of completeness that in the view of FIG. 10 one of the other slats is shown which is not provided with a magnet.

Although they show preferred embodiments of the invention, the above described embodiments are intended only to illustrate the present invention and not in any way to limit the specification of the invention. When measures in the claims are followed by reference numerals, such reference numerals serve only to contribute toward understanding of the claims, but are in no way limitative of the scope of protection. It is particularly noted that the skilled person can combine technical measures of the different embodiments. The rights described are defined by the following claims, within the scope of which many modifications can be envisaged.

1. A device for orienting slats relative to the sun, comprising:
an elongate housing;
an elongate guide connected to the housing and having engaging elements which engage the slats during use and are displaceable in the longitudinal direction of the elongate housing, wherein the slats are rotatable about a longitudinal axis thereof;
a drive which acts selectively on the rotatable slats and with which the slats, which extend substantially transversely of the elongate guide, are selectively rotatable about the longitudinal axis thereof;
a controller configured to control the drive subject to a rotational position of the slats relative to the sun; and
rotational position determining mechanism configured to determine the rotational position of the slats relative to the housing.

2. The device as claimed in claim 1, wherein the rotational position determining mechanism comprises sensors.

3. The device as claimed in claim 2, wherein the rotational position determining mechanism comprises a magnetic sensor and at least one magnet for arranging on at least one of the slats.

4. The device as claimed in claim 1, wherein the housing comprises two housing parts, wherein:
the drive is arranged in a first housing part; and
at least the controller is arranged in a second housing part; and
wherein the second housing part is selectively connectable to one of at least two sides of the first housing part.

5. The device as claimed in claim 4, wherein sensors are arranged in a recess which takes a form running from the first housing part to the second housing part in accordance with a rotation path of a slat.

6. The device as claimed in claim 5, wherein the recess arranged in the second housing part takes a mirrored form.

7. The device as claimed in claim 1, wherein the slats are received in the guide for displacement in a longitudinal direction, further comprising a translational position determining mechanism configured to determine the translational position of the slats.

8. The device as claimed in claim 7, wherein the translational position determining mechanism comprises an end position switch arranged on or close to an outer end of the guide remote from the housing.

9. The device as claimed in claim 8, wherein a magnetic connection which holds the slats in a fully drawn open position is provided on or close to the outer end of the guide remote from the housing.

10. A solar tracking system for orienting slats relative to the sun, comprising:
the orienting device as claimed in claim 1; and
at least two slats which are arranged substantially parallel adjacently of and close to each other and which are received for rotation about their longitudinal axis in the guide.

11. The solar tracking system as claimed in claim 10, wherein the longitudinal direction of the slats extends in a substantially standing plane.

12. The solar tracking system as claimed in claim 10, wherein the slats are suspended from the guide.

13. The solar tracking system as claimed in claim 10, wherein the slats comprise sun protection slats which are substantially transparent and which are provided with one or more optical elements.

14. The solar tracking system as claimed in claim 13, wherein the optical elements comprise one or more prisms.

15. The solar tracking system as claimed in claim 13, wherein the slats comprise one or more solar cells.

16. A method for orienting the slats with the orienting device as claimed in claim 1, comprising the steps of:
determining an actual rotational position of the slats;
determining a desired rotational position of the slats;
rotating the slats in a first rotation direction with the drive to a desired rotational position; and/or
rotating the slats in a second rotation direction opposite to the first rotation direction with the drive to the desired rotational position; and
wherein the controller determines the rotational displacement between the actual rotational position and the desired rotational position.

17. The method as claimed in claim 16, further comprising the step of:
measuring the actual rotational position of at least one slat with at least one magnetic sensor on or at the guide and at least one magnet on or at at least one of the slats, or with at least one magnetic sensor on or at at least one of the slats and at least one magnet on or at the guide.

18. The method as claimed in claim 17, further comprising the step of:
measuring with the at least one magnetic sensor at least one parameter from the group comprising the electromagnetic field strength and the field line orientation of the magnet.

19. The method as claimed in claim 16, further comprising the steps of:
entering into the controller or retrieving from a memory an actual time, geographical position and geographical orientation of the guide of the orienting device;
calculating, with the controller, the position of the sun relative to the guide;
calculating a desired angular position of the slats; and
controlling, with the controller, the drive on the basis of the foregoing data so that the slats are rotated such that the slats remain oriented substantially at right angles to the sun.

20. The device as claimed in claim 2, wherein the housing comprises two housing parts, wherein:
the drive is arranged in a first housing part; and
at least the controller is arranged in a second housing part; and
wherein the second housing part is selectively connectable to one of at least two sides of the first housing part.
